(19) United States
(12) Patent Application Publication
(10) Pub. No.: US 2026/0064030 A1
(43) Pub. Date: Mar. 5, 2026

(54) APPARATUS

(71) Applicant: CANON KABUSHIKI KAISHA, Tokyo (JP)

(72) Inventor: SHUN TAKAHASHI, Ibaraki (JP)

(21) Appl. No.: 19/302,501

(22) Filed: Aug. 18, 2025

(30) Foreign Application Priority Data
Aug. 29, 2024 (JP) 2024-147073

(51) Int. Cl. G03G 15/041; B41J 2/447; B41J 2/47; G03G 15/04

(52) U.S. Cl. CPC G03G 15/0415; B41J 2/447; B41J 2/47; G03G 15/04036; G03G 2215/0412

(57) ABSTRACT

An apparatus includes a member, a head including a plurality of emitting units disposed and configured to expose the member, a generation unit configured to generate image data, and output the image data as serial data, a conversion unit configured to receive the serial data, and convert the serial data into parallel data, a drive unit configured to drive the plurality of emitting units based on the parallel data, a reset unit configured to reset the conversion unit to an initial state, an output unit configured to output an enable signal, and a power source configured to supply power to the conversion unit, wherein, after the power source supplies power to the conversion unit, the output unit outputs the enable signal, and wherein, after the output unit outputs the enable signal, the reset unit resets the conversion unit.

### BACKGROUND

### Field of the Technology

The aspect of the embodiments relates to apparatuses incorporating a transmission apparatus, a reception apparatus, a transmission/reception apparatus, and a transmission/reception system.

### Description of the Related Art

An electrophotographic printer is generally known to use a method for exposing a photosensitive member by using an exposure head including light emitting elements such as light emitting diodes (LEDs).

With the recent increase in the data capacity of image forming apparatuses accompanying their improved image quality, there has been an increasing demand for a configuration for high-speed data transmission. U.S. Pat. No. 7,859,555B2 describes a high-speed communication configuration for transmitting image data through serial communication.

In the above-described communication process, normal image data communication may possibly be disturbed by external noise.

### SUMMARY

According to an aspect of the embodiments, an apparatus includes a member, a head including a plurality of emitting units disposed along a rotational axis direction of the member and configured to expose the member, a generation unit configured to generate image data for controlling ON and OFF states of the plurality of emitting units, and output the image data as serial data, a conversion unit configured to receive the image data as serial data output by the generation unit, and convert the serial data into parallel data, a drive unit configured to drive the plurality of emitting units based on the image data as parallel data converted by the conversion unit, a reset unit configured to reset the conversion unit to an initial state, an output unit configured to output an enable signal indicating a state where the conversion unit is able to receive the serial data, and a power source configured to supply power to the conversion unit, wherein, after the power source supplies power to the conversion unit, the output unit outputs the enable signal, and wherein, after the output unit outputs the enable signal, the reset unit resets the conversion unit.

Features of the disclosure will become apparent from the following description of embodiments with reference to the attached drawings. The following description of embodiments is described by way of example.

### BRIEF DESCRIPTION OF THE DRAWINGS

FIG. 1 illustrates a configuration of an image forming apparatus.

FIGS. 2A and 2B illustrate arrangements of a photosensitive drum and an exposure head.

FIGS. 3A and 3B illustrate configurations of a printed circuit board.

FIG. 4 is a block diagram illustrating an image controller unit and a printed circuit board.

FIGS. 5A and 5B are timing charts illustrating signals for controlling a light emitting element drive unit.

FIG. 6 is a flowchart illustrating job execution processing control.

FIG. 7 is a flowchart illustrating job execution processing control of an image processing apparatus according to a first exemplary embodiment.

FIGS. 8A to 8C are conceptual diagrams of operation according to the first exemplary embodiment.

FIG. 9 illustrates retraining timings for a plurality of colors.

FIG. 10 is a conceptual diagram of operation according to a second exemplary embodiment.

### DESCRIPTION OF THE EMBODIMENTS

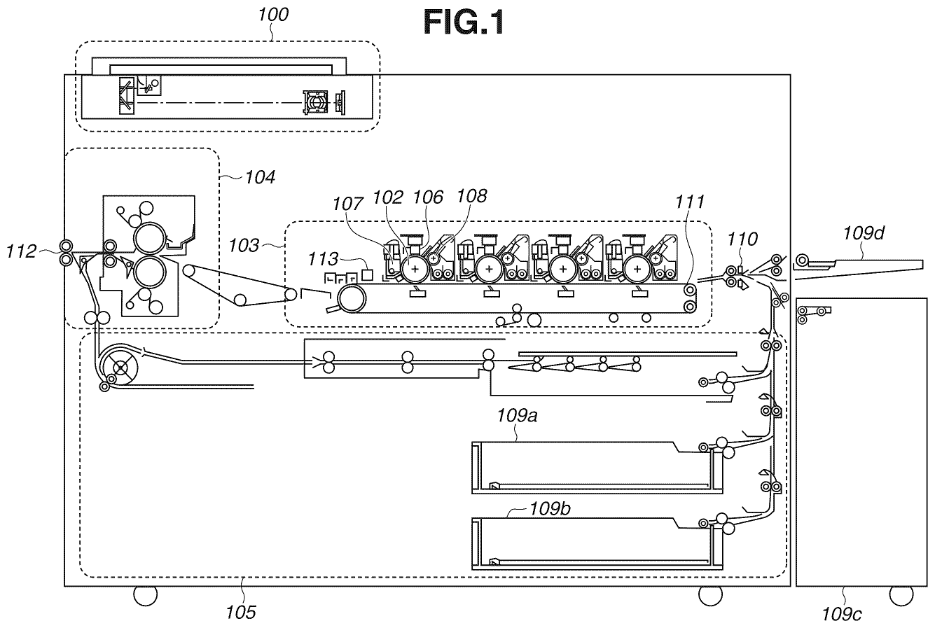

An electrophotographic image forming apparatus according to a first exemplary embodiment will be briefly described below. FIG. 1 illustrates an overall configuration of the image forming apparatus. The image forming apparatus includes a scanner unit 100, an image forming device 103, a fixing unit 104, a paper feed/conveyance unit 105, and a printer control unit (not illustrated) for controlling these units.

The scanner unit 100 illuminates a document placed on a document positioning plate, optically reads the document image, and converts the read image into an electrical signal to generate image data. The image forming device 103 rotatably drives a photosensitive drum 102 and charges the photosensitive drum 102 using a charging unit 107.

An exposure head 106 emits light in accordance with the image data and condenses the light emitted from the chip surfaces of a light emitting element group, arranged along the rotational axis direction of the photosensitive drum 102, onto the photosensitive drum 102 to form an electrostatic latent image. A development unit 108 applies a toner to the electrostatic latent image formed on the photosensitive drum 102 to develop a toner image. The developed toner image is transferred onto paper conveyed onto a transfer belt 111. The image forming device 103 includes four different image forming units for cyan (C), magenta (M), yellow (Y), and black (K) arranged in this order. Each image forming unit performs a series of the above-described electrophotographic processes (charge, exposure, development, and transfer processes) to form a full-color image. The four image forming units perform image forming operations as follows. When a predetermined time period has elapsed after the cyan station starts the image forming operation, the magenta, the yellow, and the black stations sequentially performs the image forming operation in this order. The paper feed/conveyance unit 105 supplies paper from a paper feed unit that is specified beforehand among internal paper feed units 109a and 109b, an external paper feed unit 109c, and a manual paper feed unit 109d. The supplied paper is conveyed to a registration roller 110. The registration roller 110 conveys the paper onto the transfer belt 111 at a timing when the above-described toner image formed on the image forming device 103 is transferred onto the paper. An optical sensor 113 disposed at a position facing the transfer belt 111 detects the position of a test chart printed on the transfer belt 111 to derive the mount of color misregistration between the stations. The derived amount of color misregistration is notified to an image controller unit (not illustrated), and the image position for each color is corrected. As a result of this control, a full-color toner image is transferred onto the paper without color misregistration. The fixing unit 104 is composed of a combination of rollers and incorporates a heat source such as a halogen heater. The fixing unit 104 melts and fixes the toner on the paper with the toner image transferred thereon from the transfer belt 111, with heat and pressure, and discharges the paper out of the image forming apparatus through a discharge roller 112.

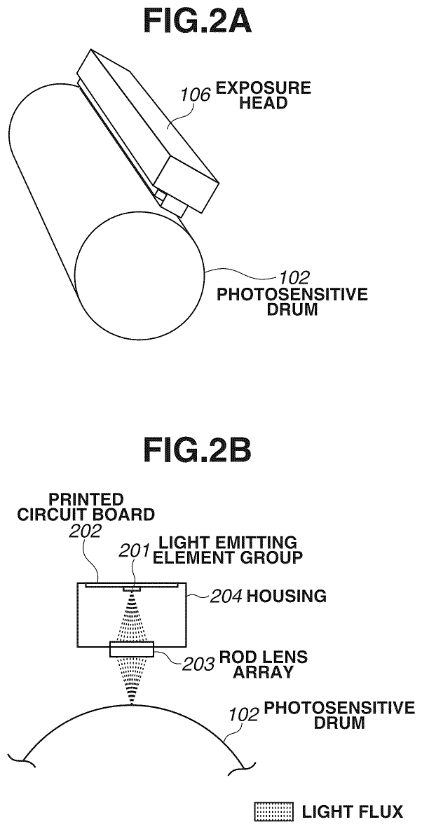

The exposure head 106 for exposing the photosensitive drum 102 to light will be described below. FIGS. 2A and 2B illustrate a how the exposure head 106 is arranged in relation to the photosensitive drum 102. The exposure head 106 includes a light emitting element group 201, a printed circuit board 202 with the light emitting element group 201 mounted thereon, a rod lens array 203, and a housing 204 to which the rod lens array 203 and the printed circuit board 202 are attached. The exposure head 106 is fixed so that the light emitted from the light emitting element group 201 is focused on the photosensitive drum 102. In other words, the light emitting element group 201 corresponds to a plurality of light emitting units.

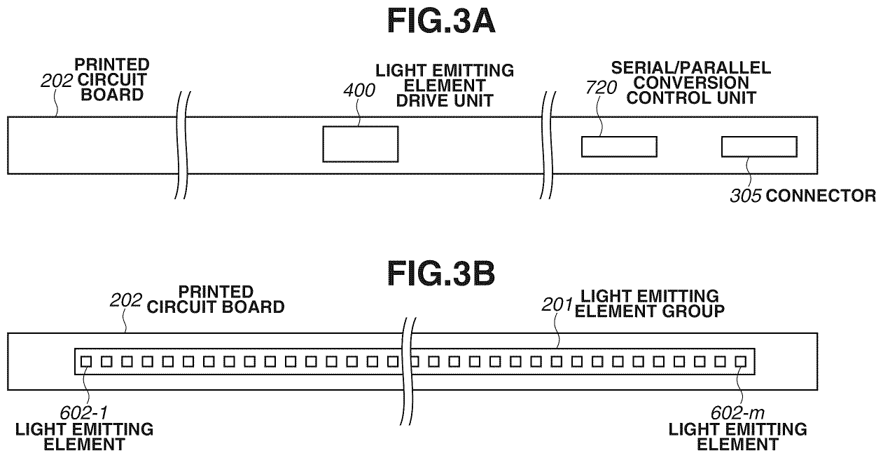

FIG. 3 illustrates a surface of the printed circuit board 202 (hereinafter this surface is referred to as a non-light emitting element mounted surface) opposite to its surface on which the light emitting element group 201 is mounted. FIG. 3B illustrates the surface of the printed circuit board 202 on which the light emitting element group 201 is mounted (hereinafter this surface is referred to as a light emitting element mounted surface). The light emitting element group 201 is formed of an array of a plurality of light emitting elements 602 (602-1 to 602-n). Inorganic light emitting diodes (LEDs) or organic electroluminescence (EL) elements are used as the plurality of light emitting elements 602. The light emitting elements 602 are arranged at intervals for a predetermined resolution in the longitudinal direction of the chip. According to the present exemplary embodiment, the interval between adjacent light emitting elements 602 in the longitudinal direction of the chip corresponds to a resolution of 1,200 dots per inch (dpi) (approximately 21.16 μm). The light emitting element group 201 includes an array of n (=14,173) light emitting elements 602. This enables image formation covering an image width of about 300 mm in the longitudinal direction of the photosensitive drum 102.

The number of light emitting elements 602 and the interval between these elements are to be considered illustrative. The number of light emitting elements 602, the interval between these elements, and the arrangement method thereof may be different.

A serial/parallel conversion control unit 720, a light emitting element drive unit 400, and a connector 305 are mounted on the non-light emitting element mounted surface of the printed circuit board 202.

The serial/parallel conversion control unit 720 has a function of recovering input serial data into parallel data. A control signal for controlling the light emitting element drive unit 400 is input to the serial/parallel conversion control unit 720 as serial data from an image controller unit (not illustrated) via the connector 305. The serial/parallel conversion control unit 720 supplies the recovered parallel data to the light emitting element drive unit 400. The power for the operation of the printed circuit board 202 is also supplied to the printed circuit board 202 via the connector 305.

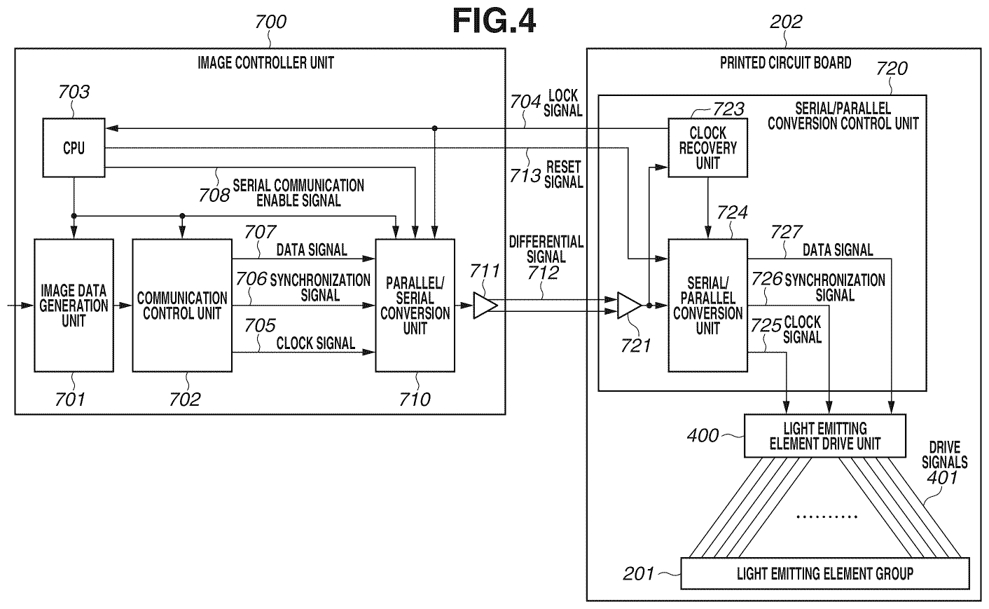

FIG. 4 is a block diagram illustrating configurations of an image controller unit 700 and the printed circuit board 202. The present exemplary embodiment performs data communication between the image controller unit 700 and the printed circuit board 202 through clock-embedded serial communication.

The image controller unit 700 has a function of generating signals for controlling the light emitting element drive unit 400 and transmitting the signals to the printed circuit board 202 according to an instruction from the printer control unit. The image controller unit 700 includes a Central Processing Unit (CPU) 703, an image data generation unit 701, a communication control unit 702, a parallel/serial conversion unit 710, and a differential signal driver 711.

The image data generation unit 701 generates signals for controlling the light emission of the light emitting element drive unit 400 according to an instruction from the printer control unit. More specifically, the image data generation unit 701 subjects image data received from the scanner unit 100 or the outside of the image forming apparatus to dithering processing with a predetermined resolution to generate image data. According to the present exemplary embodiment, the image data generation unit 701 performs the dithering processing with a resolution of 1,200 dpi in the longitudinal direction of the chip (main scanning direction) and a resolution of 1,200 dpi in the rotational direction of the photosensitive drum 102 (sub scanning direction) in alignment with the intervals of the light emitting elements 602. According to the present exemplary embodiment, the image data is binary data representing the ON and OFF states. The image data is not only binary data but also multi-valued data.

The communication control unit 702 outputs the image data generated by the image data generation unit 701, based on rotational speed information for the photosensitive drum 102. More specifically, the photosensitive drum 102 according to the present exemplary embodiment has a resolution of 1,200 dpi in the rotational direction. Therefore, the communication control unit 702 outputs the image data as a data signal 707 at a timing when the surface of the photosensitive drum 102 moves by 1,200 dpi. Further, the communication control unit 702 generates a clock signal 705, a synchronization signal 706 representing the communicated data start timing, and the data signal 707 for setting the register of the light emitting element drive unit 400. When the communication control unit 702 is requested to transmit the resister setting value to the light emitting element drive unit 400 by the CPU 703, the communication control unit 702 operates to transmit the resister setting data.

The image data and resister setting data are transmitted via a common signal line. Therefore, header information may be appended to the starting position of the data signal 707 to distinguish between the image data and the resister setting data. According to the present exemplary embodiment, the communication control unit 702 further transmits the synchronization signal 706 at the same time to identify the starting position of the transmit data.

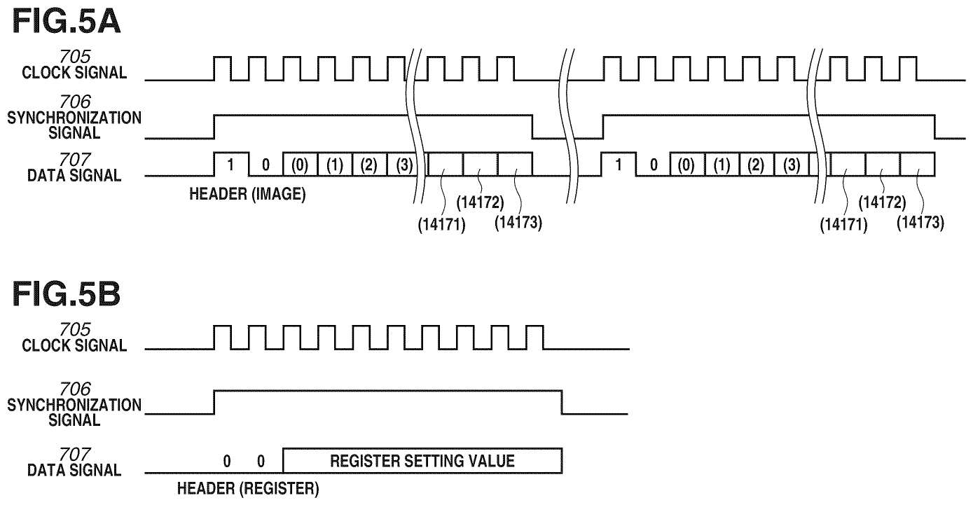

FIGS. 5A and 5B are timing charts illustrating communication states of various signals.

FIG. 5A illustrates the operation of the communication control unit 702 to transmit the image data.

While the communication control unit 702 is transmitting the data signal 707, the clock signal 705 keeps toggling. When the synchronization signal 706 is set to the High level, the data signal 707 transmits a header indicating the image data over the data signal 707 and then transmits the image data for the light emitting elements 602. When the transmission of image data is completed for all of the light emitting elements 602, all signals are set to the Low level until the next transmission starts. The communication control unit 702 repeats the above-described processing at a timing when the sub scanning resolution becomes 1,200 dpi in synchronization with the moving speed of the surface of the photosensitive drum 102 in the rotational direction, thus performing image transmission.

FIG. 5B illustrates the operation of the communication control unit 702 to transmit the resister setting data. While the communication control unit 702 is transmitting the data signal 707, the clock signal 705 keeps toggling. When the synchronization signal 706 is set to the High level, the data signal 707 transmits a header indicating the register data over the data signal 707 and then transmits the resister setting value. This processing changes setting information for a drive current for driving the light emitting elements 602, thus changing the amount of light.

The parallel/serial conversion unit 710 converts the signals output from the communication control unit 702 into a serial signal and then outputs the signal. More specifically, the parallel/serial conversion unit 710 converts the clock signal 705, the synchronization signal 706, and the data signal 707 having a plurality of bits into a serial signal, and outputs the serial signal. The differential signal driver 711 converts the serial signal output from the parallel/serial conversion unit 710 into differential signals 712 and then outputs the differential signals 712 to the printed circuit board 202.

Although, in the present exemplary embodiment, data transmission is performed between the image controller unit 700 and the printed circuit board 202 based on a pair of differential signals, two or four pairs of differential signals are also applicable depending on the transmission rate.

The printed circuit board 202 is similar to that described above with reference to FIGS. 3A and 3B, and includes the serial/parallel conversion control unit 720, the light emitting element drive unit 400, the light emitting element group 201, and the connector 305. The serial/parallel conversion control unit 720 further includes a differential signal receiver 721, a clock recovery unit 723, and a serial/parallel conversion unit 724.

The differential signals 712 output from the differential signal driver 711 are input to the printed circuit board 202 via the transmission line on the printed circuit board 202, a cable, and the connector 305, received by the differential signal receiver 721, and then converted into a normal single-ended signal. The resultant single-ended signal after conversion is input to the clock recovery unit 723, and the clock superimposed on the serial signal is recovered by the clock recovery unit 723. More specifically, the clock recovery unit 723 detects the timing of the rising or falling edge of the clock signal 705 superimposed on the serial signal. Then, the clock recovery unit 723 recovers a new clock signal based on the detected timing. The single-ended signal converted by the differential signal receiver 721 is also input to the serial/parallel conversion unit 724. The serial/parallel conversion unit 724 samples the input data by using the clock recovered by the clock recovery unit 723, converts the data into parallel signals, and then outputs the parallel signals. This means that the clock recovery unit 723 corresponds to a recovery unit.

The parallel signals output from the serial/parallel conversion unit 724 are the same as the signals output by the communication control unit 702 before being converted into a serial signal. More specifically, the serial/parallel conversion unit 724 outputs a clock signal 725, a synchronization signal 726, and a data signal 727 to the light emitting element drive unit 400.

In one embodiment, a predetermined time duration (delay) is required for a signal to pass through the parallel/serial conversion unit 710 and the serial/parallel conversion unit 724. The delay time changes depending on the form of implementation and the transmission line between chips. However, in a system having determined form of implementation and transmission line, the delay time is almost constant regardless of transmitted data.

Drive signals 401 are connected from the light emitting element drive unit 400 to the light emitting elements 602 of the light emitting element group 201. Light emitting control is performed by the drive signals 401.

The clock recovery unit 723 outputs a lock signal 704. The phase and frequency of the clock signal needs to be adjusted so that the clock recovery unit 723 normally recovers the clock signal superimposed on the serial signal. More specifically, the serial signal is input to the clock recovery unit at a predetermined timing for each bit. When recovering the clock signal superimposed on the serial signal, the serial signal needs to be sampled at intervals synchronizing with the above-described timing. If the sampling interval is not aligned in time with the input timing of the serial signal, the clock signal may not be suitably recovered. According to the present exemplary embodiment, a state where the serial signal is sampled at intervals synchronizing with the input timing of the serial signal, and the clock signal can be suitably recovered is referred to as a lock state. When the clock recovery unit 723 enters the lock state, the clock recovery unit 723 outputs the lock signal 704. The lock signal 704 means that the phase and frequency adjustment for recovering the clock signal is completed. The lock signal 704 is input to the parallel/serial conversion unit 710 and the CPU 703.

Operations of the lock signal 704 will be described below. Immediately after the power supply of the image forming apparatus is turned ON, the clock recovery unit 723 is not in the lock state. At this time, the parallel/serial conversion unit 710 transmits a communication training signal for locking the clock recovery unit 723 to the clock recovery unit 723. At this time, the CPU 703 turns ON the power supply of the serial/parallel conversion control unit 720 to receive the communication training signal (not illustrated). Then, to output the communication training signal from the parallel/serial conversion unit 710, the CPU 703 transmits a serial communication enable signal 708 to the parallel/serial conversion unit 710 to enable the start of the serial communication. In other words, the CPU 703 corresponds to an output unit. The parallel/serial conversion unit 710 can transmit the communication training signal accordingly. When the clock recovery unit 723 completes the regeneration of a clock signal, the clock recovery unit 723 sets the lock signal 704 to the Low level to notify the parallel/serial conversion unit 710 and the CPU 703 that image data transmission is possible.

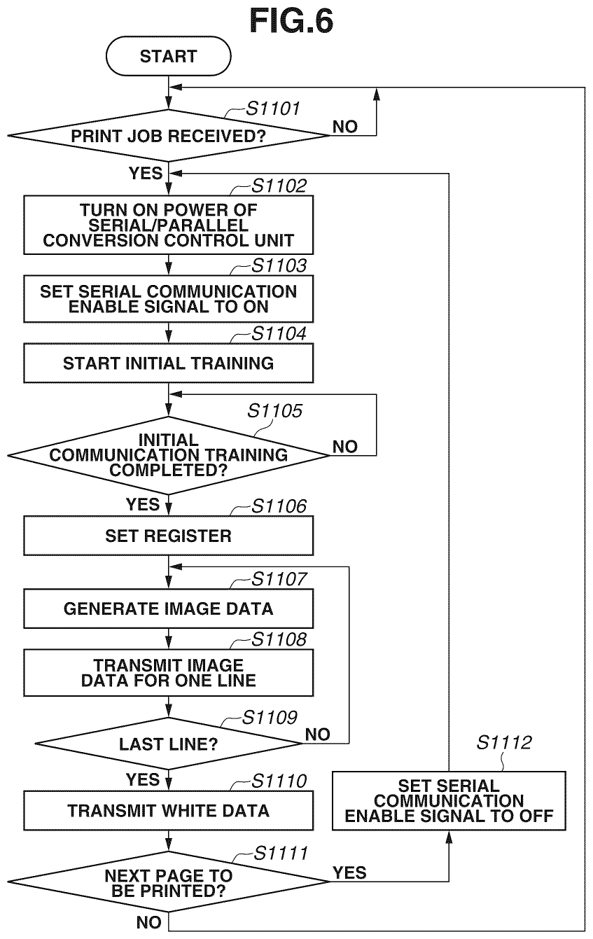

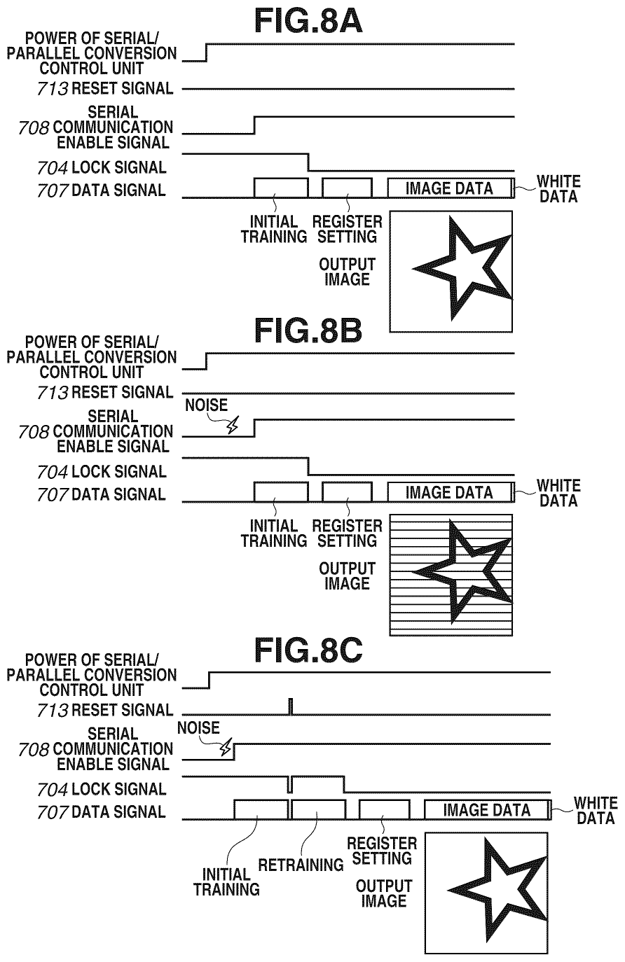

Operations from the initial training to the image data transmission will be described in detail below with reference to the flowchart in FIG. 6 and FIGS. 8A to 8C.

FIG. 6 is a flowchart illustrating job execution processing control of the image processing apparatus. Each step of the flowchart in FIG. 6 is executed by the CPU 703, and each piece of processing is implemented when each element of the image processing apparatus is controlled by the CPU 703.

In step S1101, the CPU 703 determines whether the image forming apparatus receives a print job.

When the power supply of the image processing apparatus is turned ON in step S1101, the image processing apparatus waits for a print job to be received. When the image processing apparatus receives a print job (YES in step S1101), the processing proceeds to step S1102.

In step S1102, to receive a communication waveform from the parallel/serial conversion unit 710, the CPU 703 turns ON the power supply of the serial/parallel conversion control unit 720 so that the serial/parallel conversion unit 724 is supplied with power.

In step S1103, the CPU 703 sets a serial communication enable signal 708 to ON.

In step S1104, the CPU 703 starts the initial communication training of a serial communication unit (not illustrated). The initial communication training is performed by the parallel/serial conversion unit 710 and the serial/parallel conversion control unit 720. When the initial communication training is completed, the lock signal 704 is set to the Low level, and then the parallel/serial conversion unit 710 and the CPU 703 is notified of it. Then, the image data transmission via the serial communication unit is enabled.

In step S1105, the CPU 703 determines whether the initial training of the serial communication unit is completed. When the initial communication training of the serial communication unit is completed (YES in step S1105), the processing proceeds to step S1106.

In step S1106, the CPU 703 performs a resister setting operation. The communication control unit 702 performs an operation for transmitting the resister setting data of the light emitting element drive unit 400 in accordance with an instruction from the CPU 703, so that the setting information for the drive current for driving the light emitting elements 602 is set.

In step S1107, the image data generation unit 701 generates the above-described image data. More specifically, the image data generation unit 701 generates image data having the resolution corresponding to the resolution of the image to be formed. The present exemplary embodiment generates image data having a resolution of 1,200 dpi in both the main and the sub scanning directions when it is printed.

In step S1108, the image data generation unit 701 outputs the image data generated at predetermined intervals. The communication control unit 702 is controlled to output the image data generated at the predetermined intervals based on information about the moving speed of the surface of the photosensitive drum 102 in the rotational direction. The data output from the communication control unit 702 is supplied to the light emitting element drive unit 400 via the parallel/serial conversion unit 710 and the serial/parallel conversion unit 724. Each light emitting element emits light under the control of the light emitting element drive unit 400, and image formation is performed for each line. When this operation is performed for up to the last line, image formation for one page is completed.

In step S1109, the CPU 703 determines whether the line for which the image data is transmitted in step S1108 is the last line.

When the line is not the last line (NO in step S1109), the processing returns to step S1107. In step S1107, the CPU 703 repeats the image transmission. If the line is the last line (YES in step S1109), the processing proceeds to step S1110.

In step S1110, the CPU 703 performs processing to stop the light emission of the light emitting element group 201. After outputting the image data of the last line, then in step S1110, white data is output to stop the light emission of the light emitting element group 201.

In step S1111, the CPU 703 determines whether a series of printing operations is completed. If there is the next page to be printed (YES in step S1111), the processing proceeds to step S1112. In step S1112, the CPU 703 sets the serial communication enable signal 708 to OFF. Then, the processing returns to step S1102. In step S1102, the CPU 703 repeats similar processing to perform continuous printing operations. If there is no next page to be printed (NO in step S1111), the processing returns to step S1101. The CPU 703 waits for a print job to be received again.

FIG. 8A illustrates the operations of the flowchart illustrated in FIG. 6. The CPU 703 turns ON the power supply of the serial/parallel conversion control unit 720. The serial communication enable signal 708 to the parallel/serial conversion unit 710 is set to ON. FIG. 8A shows that the initial training is completed thereafter, and the image data transmission is normally performed. On the other hand, before the serial communication enable signal 708 is set to ON, the impedance of the serial communication terminal is high, and the voltage is unsettled (Hi-Z state). In the Hi-Z state, the voltage of the serial communication terminal is unstable and largely changed by a slight current variation. Therefore, when the serial communication terminal is in the Hi-Z state, the terminal voltage is susceptible to and largely changed by a disturbance, such as noise.

An example case will be considered below, where the serial communication terminal is in the Hi-Z state and is affected by noise with the serial/parallel conversion control unit 720 supplied with power. In this case, the serial/parallel conversion control unit 720 may malfunction to disturb the normal transmission of the resister setting and image data.

FIG. 8B illustrates a timing when the image formation is affected by noise and an occurrence of an image forming failure. In a state where the serial communication enable signal 708 is set to OFF with the serial/parallel conversion control unit 720 supplied with power, the serial/parallel conversion unit 724 may possibly malfunction if noise enters the serial communication unit, as illustrated in FIG. 8B. Then, the initial training is performed after the serial communication enable signal 708 is set to ON. After completion of the initial training, the clock signal 704 enters the lock state. However, the serial/parallel conversion unit 724 malfunctions by the noise that has occurred before the initial training, the serial/parallel conversion unit 724 cannot normally transmit the image data, and hence an image failure occurs.

Accordingly, the present exemplary embodiment performs the training at a timing when the influence of a noise disturbance has sufficiently decreased after the serial communication enable signal 708 is set to ON. More specifically, the serial/parallel conversion control unit 720 is reset, and the training is performed before setting the resister. The serial/parallel conversion unit 724 according to the present exemplary embodiment has a buffer region (not illustrated) for temporarily storing the received data. If the serial/parallel conversion unit 724 is affected by noise or malfunction, incorrect information may remain in the buffer region. By resetting the serial/parallel conversion unit 724, the incorrect information remaining in the buffer region can be cleared, thereby enabling the serial/parallel conversion unit 724 to operate in a stable state. As a result, the above-described processing enables the outputting of correct image data even if the image formation is affected by noise before the serial communication enable signal 708 is set to ON.

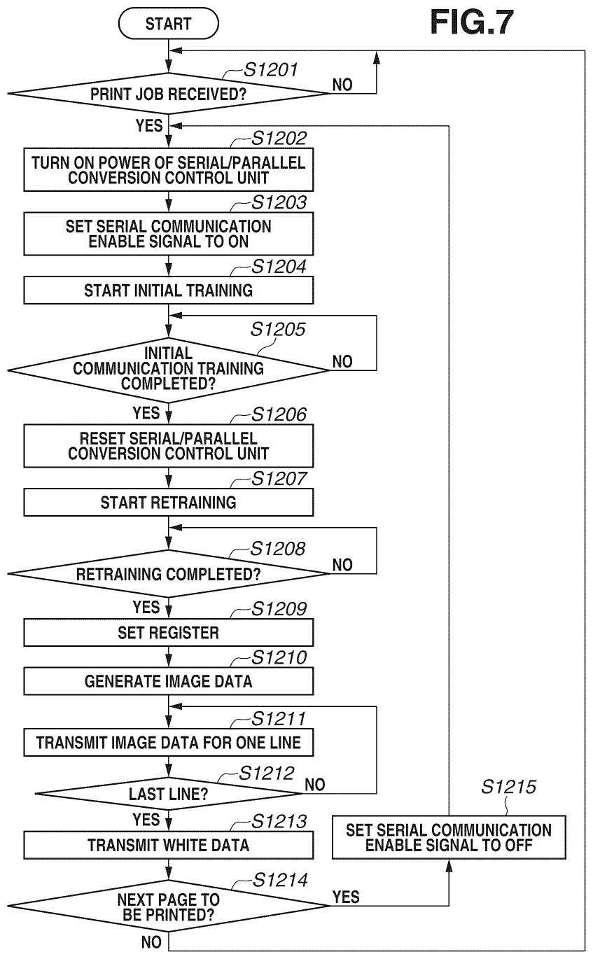

FIG. 7 is a flowchart illustrating job execution processing control for the image processing apparatus according to the present exemplary embodiment.

Processing in steps S1201 to S1205 is similar to the processing in steps S1101 to S1105 illustrated in FIG. 6, respectively, and redundant descriptions thereof will be omitted.

In step S1206, the CPU 703 resets the serial/parallel conversion unit 724. The CPU 703 transmits a reset signal 713 to the serial/parallel conversion unit 724. In other words, the CPU 703 corresponds to a reset unit. Upon reception of the reset signal 713, the serial/parallel conversion unit 724 enters the initial state. The CPU 703 transmits the reset signal 713 to the serial/parallel conversion unit 724 to initialize the serial/parallel conversion unit 724, so that the serial/parallel conversion unit 724 can be restored to a normal state even if the serial/parallel conversion unit 724 malfunctions by the noise that has occurred while the serial communication enable signal 708 is set to OFF.

In step S1207, the CPU 703 performs the training again. The CPU 703 instructs the parallel/serial conversion unit 710 to perform the training again. FIG. 8C illustrates the image forming state when the training is performed again. FIG. 8C illustrates a state where noise enters the serial communication unit while the serial communication enable signal 708 is set to OFF, and the serial/parallel conversion unit 724 malfunctions.

After noise enters the serial communication unit, the CPU 703 resets the serial/parallel conversion unit 724 to its initial state by using the reset signal 713. Then, the CPU 703 subjects the serial/parallel conversion unit 724 to the training again, and establishes a serial communication again to restore the serial/parallel conversion unit 724 to the normal state. As a result, the resister setting and image data can be normally transmitted even if the image formation is affected by noise while the serial communication enable signal 708 is set to OFF.

In step S1208, the CPU 703 determines whether the training is completed again. In a case where the training is completed again (YES in step S1208), the processing proceeds to step S1209.

Processing in steps S1209 to S1215 is similar to the processing in steps S1106 to S1112 illustrated in FIG. 6, respectively, and redundant descriptions thereof will be omitted.

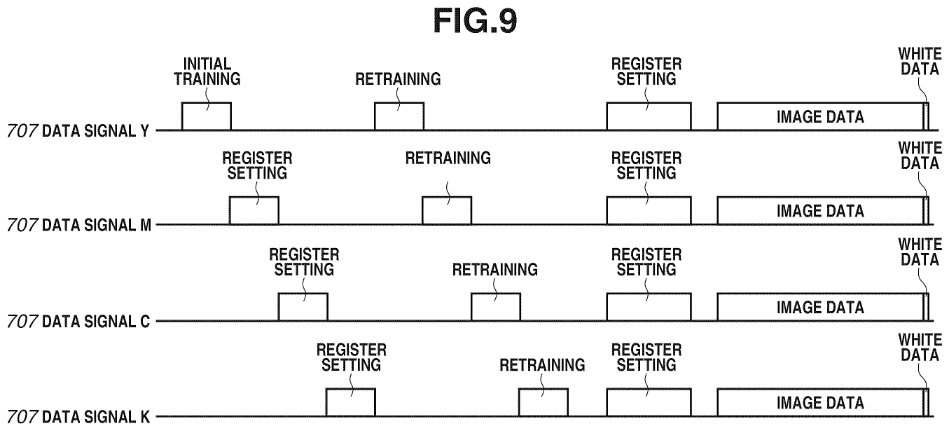

A method has been described above centering on single-color processing. However, an image forming apparatus for forming a color image performs similar processing for four different colors. FIG. 9 illustrates timings of four-color retraining for the YMCK colors. The flowchart of the training for each color is the same as the flowchart illustrated in FIG. 7. Meanwhile, the training start timing is controlled to prevent the overlapping of the training periods of the respective colors. As illustrated in FIG. 9, the initial training for yellow is started according to the flowchart in FIG. 7. When the initial training for yellow is completed, the initial training for magenta is performed. Likewise, the initial training is also performed for cyan and black. At this time, the training start timing for magenta is delayed with respect to the training start timing for yellow to prevent the overlapping of the training periods of the respective colors. Likewise, the training start timing for cyan is delayed with respect to the training start timing for magenta, and the training start timing for black is delayed with respect to the training start timing for cyan. Since the data signal toggles at high speed during training communication, the intensity of radiated noise increases. Therefore, the intensity of radiated noise further increases if the training periods of the respective colors overlap. For this reason, the training start timings are controlled to prevent the overlapping of the training periods of the respective colors. When the initial training for black is completed, the CPU 703 starts the retraining for yellow according to the flowchart in FIG. 7. For the retraining for magenta, cyan, and black, the training start timings are controlled to prevent the overlapping of the training periods of the respective colors, like the case of the initial training.

As described above, when forming a color image and performing the training for each color, the data signal in the training communication serves as a noise emission source, possibly causing the serial/parallel conversion unit 724 to malfunction. On the other hand, by adjusting the timings so that the training periods for the respective colors do not overlap each other, it is possible to reduce the influence of noise and increase the resistance to malfunction of the serial/parallel conversion unit 724 for each color.

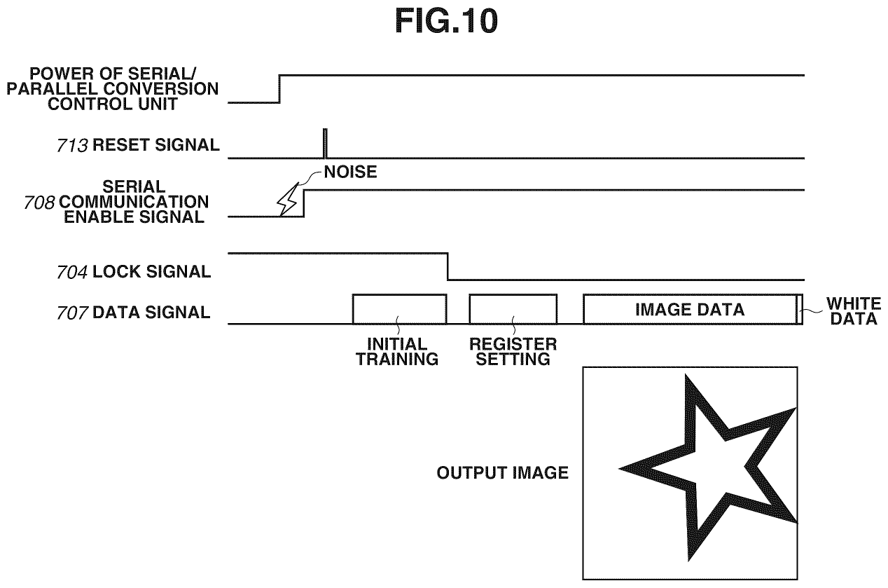

According to the first exemplary embodiment, the initial training is started at the same time when the serial communication enable signal 708 is set to ON. A second exemplary embodiment will be described below centering on an example where the initial training can be performed at any desired timing asynchronously with the serial communication enable signal 708. If the timing of the initial training can be optionally determined, the CPU 703 transmits the reset signal 713 for resetting the serial/parallel conversion unit 724 to the serial/parallel conversion unit 724 after the serial communication enable signal 708 is set to ON, as illustrated in FIG. 10.

Performing the initial training after the above-described operation enables omitting the retraining, which is performed in first exemplary embodiment. This enables the second exemplary embodiment to provide similar effects to the first exemplary embodiment.

The aspect of the embodiments is directed to reducing the possibility that normal data communication is disturbed in an image forming apparatus that communicates data through serial communication.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-147073, filed Aug. 29, 2024, which is hereby incorporated by reference herein in its entirety.

What is claimed is:

1. An apparatus comprising:
a member;
a head including a plurality of emitting units disposed along a rotational axis direction of the member and configured to expose the member;
a generation unit configured to generate image data for controlling ON and OFF states of the plurality of emitting units, and output the image data as serial data;
a conversion unit configured to receive the image data as serial data output by the generation unit, and convert the serial data into parallel data;
a drive unit configured to drive the plurality of emitting units based on the image data as parallel data converted by the conversion unit;
a reset unit configured to reset the conversion unit to an initial state;
an output unit configured to output an enable signal indicating a state where the conversion unit is able to receive the serial data; and
a power source configured to supply power to the conversion unit,
wherein, after the power source supplies power to the conversion unit, the output unit outputs the enable signal, and
wherein, after the output unit outputs the enable signal, the reset unit resets the conversion unit.

2. The apparatus according to claim 1, wherein, after the reset unit resets the conversion unit, the generation unit outputs the image data as serial data.

3. The apparatus according to claim 2, wherein the generation unit superimposes a clock signal for driving the conversion unit on the serial data, and outputs the serial data.

4. The image forming apparatus according to claim 3, further comprising a restoration unit configured to restore the clock signal superimposed on the serial data.

5. The apparatus according to claim 2, wherein the plurality of emitting units are organic electroluminescence (EL) elements.

6. The apparatus according to claim 1, wherein the generation unit superimposes a clock signal for driving the conversion unit on the serial data, and outputs the serial data.

7. The apparatus according to claim 6, wherein, after the reset unit resets the conversion unit, the generation unit outputs the image data as serial data.

8. The apparatus according to claim 6, wherein the plurality of emitting units are organic electroluminescence (EL) elements.

9. The apparatus according to claim 6, further comprising a restoration unit configured to restore the clock signal superimposed on the serial data.

10. The apparatus according to claim 1, wherein the plurality of emitting units are organic electroluminescence (EL) elements.

11. The apparatus according to claim 10, wherein, after the reset unit resets the conversion unit, the generation unit outputs the image data as serial data.

12. The apparatus according to claim 10, wherein the generation unit superimposes a clock signal for driving the conversion unit on the serial data, and outputs the serial data.

13. The apparatus according to claim 12, further comprising a restoration unit configured to restore the clock signal superimposed on the serial data.
